(19) United States
(12) Patent Application Publication
(10) Pub. No.: US 2014/0151219 A1
(43) Pub. Date: Jun. 5, 2014

(54) SILVER ELECTRODE COATED WITH CARBON NANOTUBES

(71) Applicant: KING FAHD UNIVERSITY OF PETROLEUM AND MINERALS, DHAHRAN (SA)

(72) Inventors: ABDALLA M. ABULKIBASH, DHAHRAN (SA); MOATAZ ALI ATEIEH, DHAHRAN (SA); ABDULAZIZ NABIL AMRO, DHAHRAN (SA)

(73) Assignee: KING FAHD UNIVERSITY OF PETROLEUM AND MINERALS, DHAHRAN (SA)

(21) Appl. No.: 13/705,100

(22) Filed: Dec. 4, 2012

(51) Int. Cl. G01N 27/30

(52) U.S. Cl. CPC G01N 27/30; B82Y 15/00
USPC 204/400; 427/113; 977/902; 977/843

(57) ABSTRACT

The silver electrode coated with carbon nanotubes is an indicator electrode for microtitrimetry by differential electrolytic potentiometry. The electrode is made by first positioning at least one silver wire electrode within a reaction zone of a floating catalyst chemical vapor deposition reactor. A ferrocene catalyst is evaporated within the floating catalyst chemical vapor deposition reactor, and an inlet gas is fed therein to carry the evaporated ferrocene catalyst into the reaction zone. The inlet gas includes hydrogen and a carbon source, such as acetylene. The reaction zone is then heated for deposition of carbon onto the at least one silver electrode to form at least one silver electrode coated with carbon nanotubes. The electrode is cooled and then removed from the reactor.

### BACKGROUND OF THE INVENTION

1. Field of the Invention

The present invention relates to indicator potentiometric electrodes, and particularly to a silver electrode coated with carbon nanotubes used for microtitrimetry by differential electrolytic potentiometry.

2. Description of the Related Art

Potentiometric microtitration is a technique similar to direct titration of a redox reaction. No indicator is used. Rather, the potential across the analyte, typically an electrolyte solution, is measured. To do this, two electrodes are used, an indicator electrode and a reference electrode. The indicator electrode forms an electrochemical half-cell with the interested ions in the test solution. The reference electrode forms the other half cell, holding a consistent electrical potential.

Common reference electrodes are typically either silver-silver chloride or mercury sulfate electrodes, and common indicator electrodes are often made as glass electrodes, platinum electrodes, silver electrodes or ion-selective electrodes. A typical potentiometric measurement system is diagrammatically illustrated in FIG. 1. The system includes an indicator electrode 12 and a reference electrode 14 immersed within a cell C holding analyte A. A potentiometer 16 measures the potential across the two electrodes for determining ionic concentration within the analyte A. FIG. 1 illustrates a typical setup for conventional potentiometry. Differential electrolytic potentiometry (DEP), however, is a technique that utilizes two identical metallic electrodes that are polarized by a heavily stabilized current, and the potential difference between them is measured. At the end-point, this potential difference produces a sharp symmetrical peak. The DEP technique does not require a reference electrode. Thus, the difficulties of the salt bridge are eliminated. For differential electrolytic potentiometry, the system of FIG. 1 would be modified so that two identical indicator electrodes would be used, rather than an indicator electrode 12 and a reference electrode 14. Further, polarization enhances the response of the electrodes. This technique may be applied to various types of titrimetric reactions using different types of electrodes.

For the complexation microtitration of cyanide, silver indicator electrodes are commonly used. Although accurate for relatively large sample sizes, the accuracy and precision of pure silver electrodes decreases as the sample size decreases. In general, for DEP, silver electrodes and silver-silver halide electrodes have been found to be suitable for precipitation reactions, while antimony oxide electrodes have been found to be suitable for acid-base reactions. These electrodes also suffer from the problem of a decrease in accuracy as a function of sample size, thus limiting their use based on sample size.

Thus, a silver electrode coated with carbon nanotubes solving the aforementioned problems is desired.

### SUMMARY OF THE INVENTION

The silver electrode coated with carbon nanotubes is used for microtitrimetry by differential electrolytic potentiometry. The electrode is made by positioning at least one silver electrode within a reaction zone of a floating catalyst chemical vapor deposition reactor. A ferrocene catalyst is evaporated within the reactor, and an inlet gas is fed therein to carry the evaporated ferrocene catalyst into the reaction zone. The inlet gas includes hydrogen and a carbon source, such as acetylene.

The reaction zone is then heated for deposition of carbon onto the silver electrode(s) to form at least one silver electrode coated with carbon nanotubes. The electrode is then cooled and removed from the reactor.

These and other features of the present invention will become readily apparent upon further review of the following specification and drawings.

### BRIEF DESCRIPTION OF THE DRAWINGS

FIG. 1 diagrammatically illustrates a typical potentiometric measurement system according to the prior art.

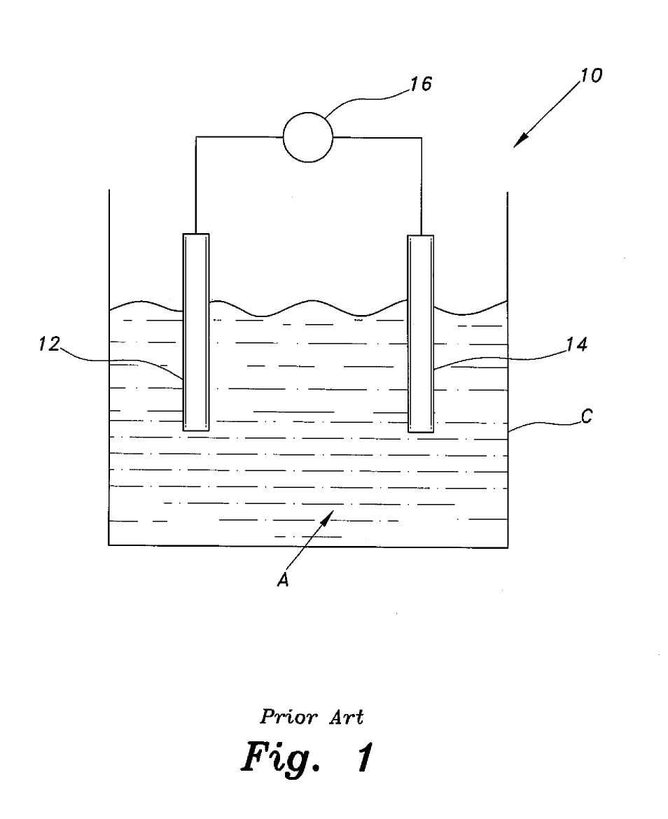

FIG. 2 is a graph illustrating potentiometric measurements associated with the complexation microtitration of a 10 μL sample of cyanide using a pure silver electrode.

FIG. 3 is a graph illustrating potentiometric measurements associated with the complexation microtitration of a 4 μL sample of cyanide using a pure silver electrode.

FIG. 4 is a graph illustrating potentiometric measurements associated with the complexation microtitration of a 10 μL sample of cyanide using a silver electrode coated with carbon nanotubes according to the present invention.

FIG. 5 is a graph illustrating potentiometric measurements associated with the complexation microtitration of a 1.2 μL sample of cyanide using a silver electrode coated with carbon nanotubes according to the present invention.

FIG. 6 is a graph illustrating potentiometric measurements associated with the microtitration of a 4.0 μL sample of ketoconazole using a pure gold electrode.

FIG. 7 is a graph illustrating potentiometric measurements associated with the microtitration of a 2.0 μL sample of ketoconazole using a pure gold electrode.

FIG. 8 is a graph illustrating potentiometric measurements associated with the microtitration of a 4.0 μL sample of ketoconazole using the silver electrode coated with carbon nanotubes according to the present invention.

FIG. 9 is a graph illustrating potentiometric measurements associated with the microtitration of a 2.0 μL sample of ketoconazole using the silver electrode coated with carbon nanotubes according to the present invention.

FIG. 10 is a graph illustrating potentiometric measurements associated with the microtitration of a 25 μL, sample of ketoconazole using a pure antimony electrode for.

FIG. 11 is a graph illustrating potentiometric measurements associated with the microtitration of ketoconazole using a pure antimony electrode for a 10 μL sample.

FIG. 12 is a graph illustrating potentiometric measurements associated with the microtitration of a 20 μL sample of ketoconazole using the silver electrode coated with carbon nanotubes according to the present invention.

Similar reference characters denote corresponding features consistently throughout the attached drawings.

### DETAILED DESCRIPTION OF THE PREFERRED EMBODIMENTS

In order to make silver electrodes coated with carbon nanotubes, floating catalyst chemical vapor deposition (FC-CVD) is used. In the experiment described in detail below, a horizontal tubular FC-CVD reactor was used, although it should be understood that any suitable type of FC-CVD reactor may be used. The exemplary horizontal reactor used in the experiment included a quartz tube having a diameter of 2.5 cm and a length of 125 cm. The heating element was a silicon carbide heating element. Silver wire electrodes, each with a length of 2 cm and a diameter of 1.0 mm, were placed on a ceramic boat on a front side of the reactor tube.

A catalyst boat containing about 100 mg of ferrocene (FeC₁₀ H₁₀ with 98% purity) was placed within the first reaction chamber of the FC-CVD reactor. A separated heating element with a thermocouple was used within the first 25 cm of the reactor tube to evaporate the catalyst at a temperature of about 120° C. The evaporation was then carried by the inlet of gases into the furnace, or reaction zone, of the FC-CVD reactor, where the carbon nanotubes were formed on the silver electrodes through chemical vapor deposition.

Argon gas was first introduced into the reactor for flushing and removal of air prior to reaction. Following flushing with the inert gas, the furnace of the first chamber was heated and maintained at a temperature of about 120° C. The inlet gas was composed of hydrogen gas (with a 99% purity), introduced as a carrying gas and a reducing agent, and acetylene (C₂H₂ with a 99.5% purity) as a carbon source.

Following the deposition reaction, during the cooling process, argon gas was delivered to purge the interior of the reaction tube to prevent oxidation of the carbon nanotubes. Following this process, the silver electrodes, now coated with carbon nanotubes, were removed from the reactor.

Several experiments were performed to study reaction temperatures ranging from 500° C. to 850° C., while the hydrogen to hydrocarbon flow rate was been also varied from 10-1000 ml/min for hydrogen and from 25-300 ml/min for the hydrocarbon. It was found that in order to sustain the optimum catalyst-carbon deposition activity for the growth of high purity carbon nanotubes on the surface of the silver electrodes, it was necessary to maintain the level of the hydrogen flow rate at about 25 ml/min, along with a flow rate of approximately 75 ml/min for the acetylene gas throughout the reaction period. At a hydrogen flow rate of less than 25 ml/min, there was found to be no growth of carbon nanotubes on the surface of the silver electrodes, as there was insufficient hydrogen gas within the reaction zone.

To obtain high yield and purity, optimization of the reaction temperature was carried out and the optimized value was investigated. Scanning electron microscopy revealed that carbon nanotubes could not grow below 600° C. or above 850° C. For reaction temperatures between 600° C. and 750° C., carbon nanotubes were observed with optimal yield and purity. At a reaction temperature of 800° C., significant amorphous carbon was found to be mixed with varying quantities of nanotubes. Increasing the temperature to 850° C. resulted in the formation of carbon fibers.

With regard to reaction time, no carbon nanotube growth was observed for short reaction times of 10 minutes or less. An increase of the reaction time to 15 minutes was found to provide sufficient time for the completion of the formation of the growth of the nanotubes. Increases of the reaction time above 15 minutes produced significant quantities of amorphous carbon and reduced the purity of the carbon nanotubes.

Transition electron microscopy revealed that the produced carbon nanotubes were, as desired, hollow and tubular in shape. In some images, catalyst particles could be seen inside the nanotubes. The images showed produced nanotubes having diameters ranging from between 10 nm and 30 nm. These high purity nanotubes with uniform diameter distribution and no deformity in structure were produced with a hydrogen flow rate of 25 ml/min. It was further observed that the shape of the catalyst, which served as a seed during the reaction process, was important, as the produced nanotubes followed the shape of the catalyst.

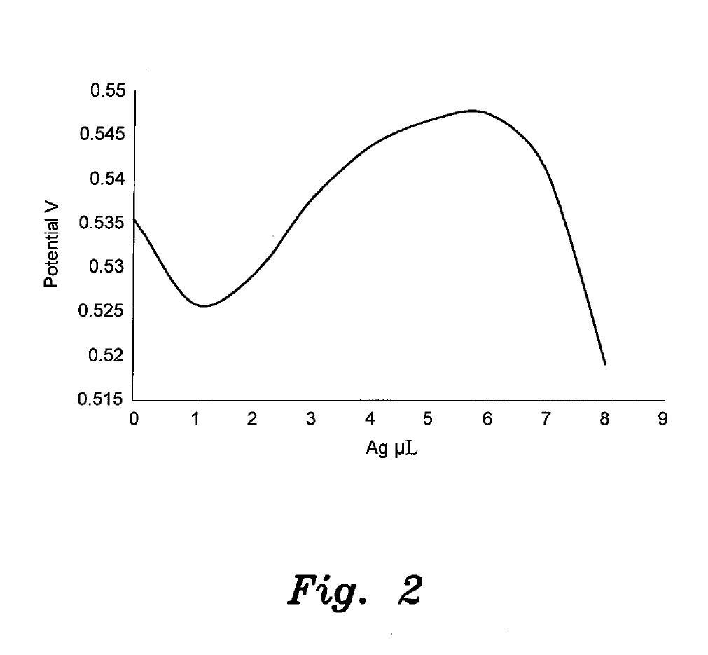

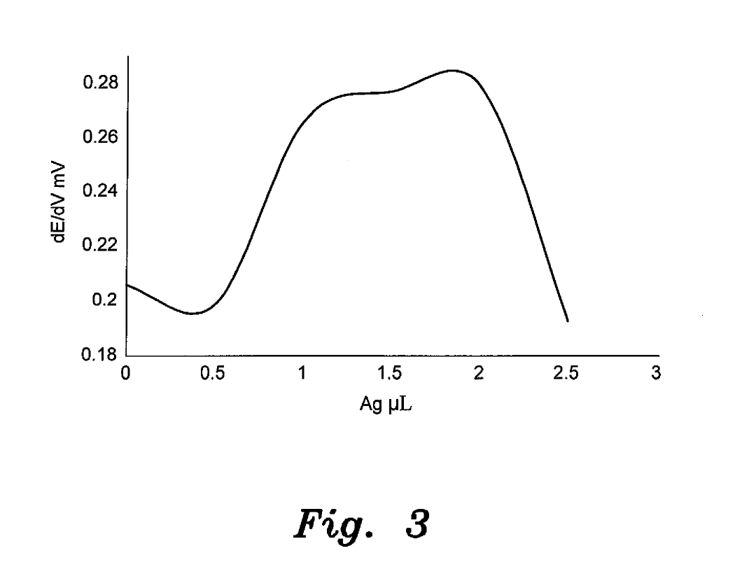

The silver electrode coated with carbon nanotubes has been tested as an indicator electrode for the complexation microtitration of cyanide. Cyanide reacts with silver nitrate by the complexation reaction AgNO_{3(aq)}+2KCN_{(aq)}→[Ag(CN)₂₍ₛ₎]⁻+KNO_{3(aq)}. The silver electrode coated with carbon nanotubes was used in this microtitration with a mark-space bias of 5%, tested against a bare silver electrode with an RSD value of 8.4% (n=3). FIG. 2 illustrates measured potential using the bare silver electrode with a 10 μL sample. FIG. 3 illustrates measured potential with a smaller 4 μL sample. Both samples had a 0.05 M concentration. The broader peak of the 4 μL sample should be noted, as this indicates a limit in accuracy using the bare silver electrode,

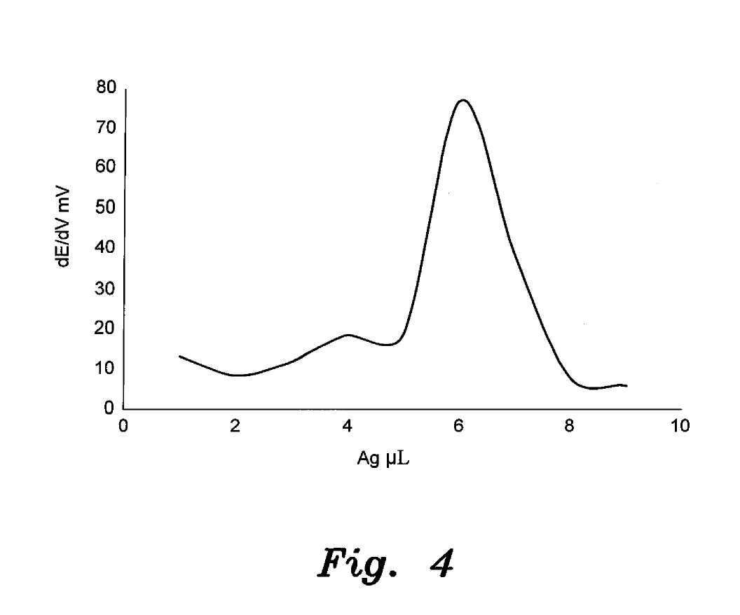

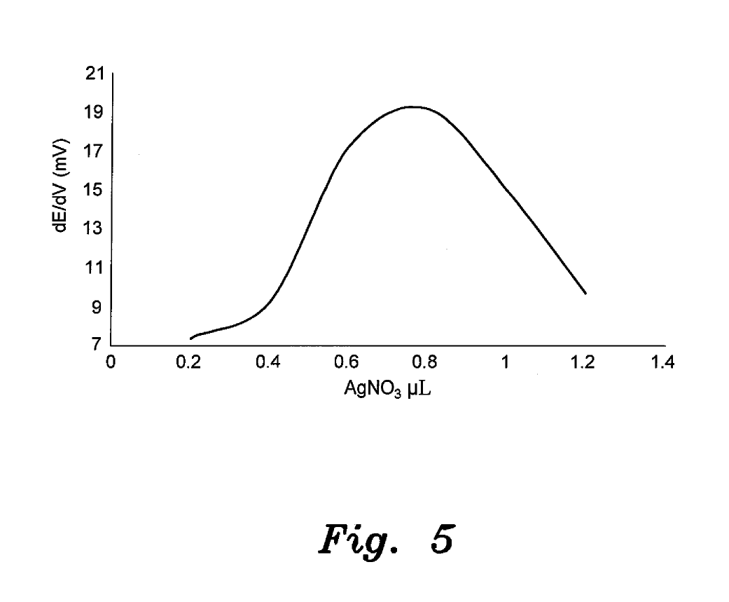

For the silver electrode coated with carbon nanotubes, the first derivative of the potential is required to locate the endpoint of the titration. Significant modifications were achieved, as shown in FIG. 4, which shows the results for a 10 μL sample. Since microtitration using the silver electrode coated with carbon nanotubes generates sharper peaks, compared to those of the bare electrode, this sensitivity makes it possible to analyze smaller sample volumes, as compared to the bare silver electrode. FIG. 5 shows the smallest possible sample volume of 1.2 μL with a 0.05 M concentration that can be titrated using the silver electrode coated with carbon nanotubes.

Table 1 shows a comparison between the bare silver electrode and the silver electrode coated with carbon nanotubes according to the results of three replicates (n=3). It can be seen that the silver electrode coated with carbon nanotubes provides more accurate and precise results.

TABLE 1
Accuracy and Precision of Cyanide Sample Microtitration

| | | | | Standard |
|---|---|---|---|---|
| Electrode | Sample Mass (μg) | Recovery % | RSD % | Deviation |
| Silver | 32.6 | 106.6 | 8.41 | 0.005 |
| Silver/CNTs | 16.3 | 103.3 | 5.58 | 0.006 |

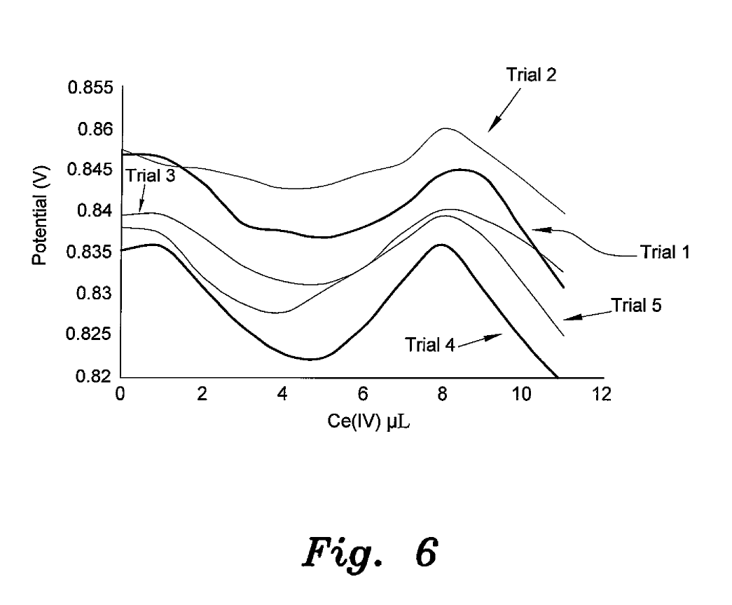

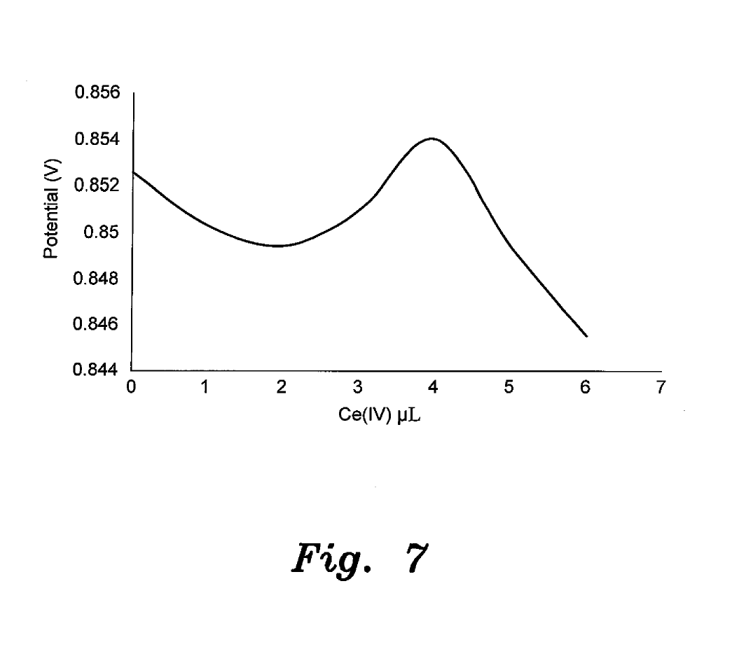

The silver electrode coated with carbon nanotubes was also tested for the microtitration of ketoconazole in both aqueous and non-aqueous media. In this test, gold electrodes were used for the oxidation-reduction microtitration of ketoconazole. For the reaction KC+2 Ce (IV)→KC²⁺+2Ce (III), five replicated trials are shown in FIG. 6 for Ce (IV) at 0.1 M concentration vs. standard ketoconazole at 0.05 M concentration with a sample size of 4.0 μL using the gold electrode. FIG. 7 shows the same reaction results, but for a sample size of 2.0 μL also using the gold electrode. These tests were performed with a 5% bias.

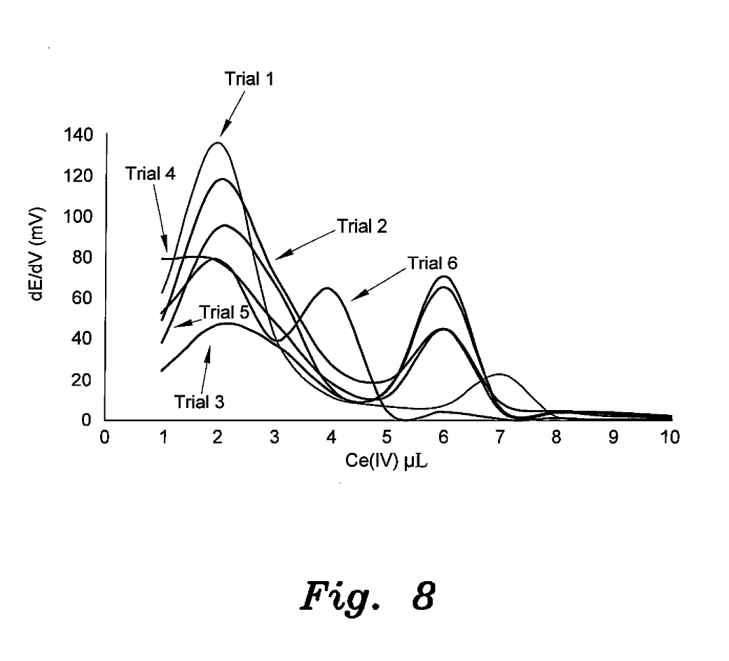

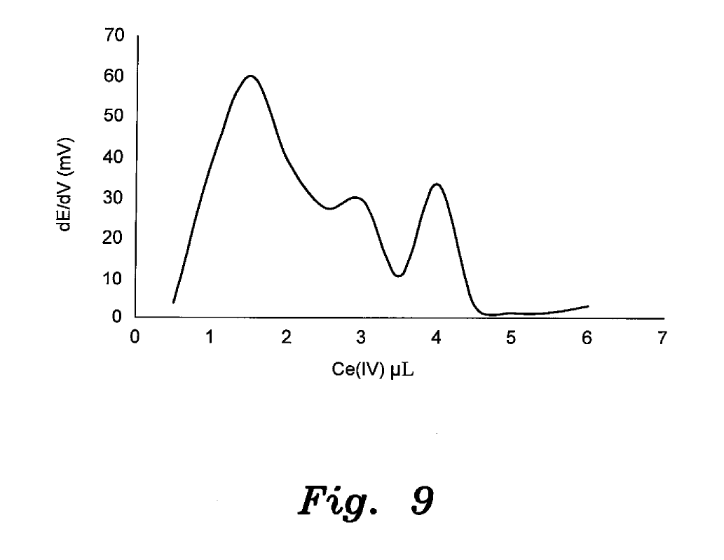

FIG. 8 illustrates two peaks formed for the first derivative of microtitration of ketoconazole vs. Ce (IV) using the silver electrode coated with carbon nanotubes. The first peak is found at a one-to-one molar ratio, and the second peak is found at a three-to-one molar ratio. FIG. 8 shows experimental results for a sample size of 4.0 μL. Three peaks are found for the smaller sample size of 2.0 μL, shown in FIG. 9. In FIGS. 6-9, the Ce (IV) has a concentration of 0.1 M and the ketoconazole has a concentration of 0.05 M.

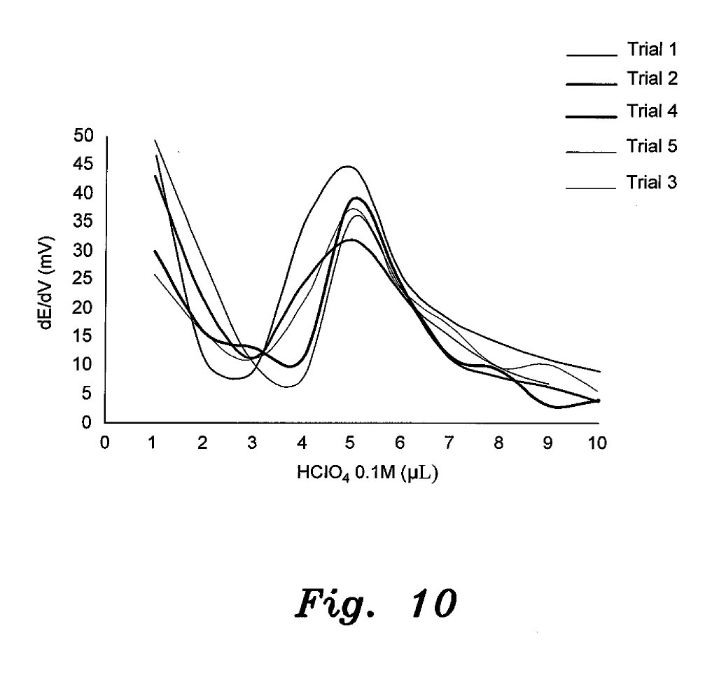

For the testing of non-aqueous microtitration, perchloric acid (HClO₄) was used as a standard in acid-base non-aqueous microtitration of ketoconazole. Reaction between the HClO₄ and the ketoconazole was in a two-to-one molar ratio. FIG. 10 illustrates five replicates of ketoconazole microtitration using antimony electrodes with a 5% bias. The ketoconazole and the HClO₄ were each provided with a 0.1 M concentration. FIG. 10 shows the results for a 25 μL sample size.

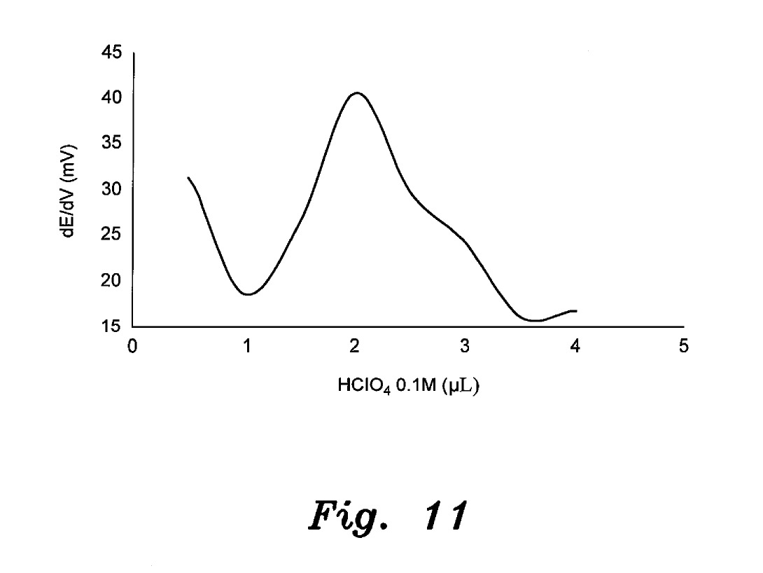

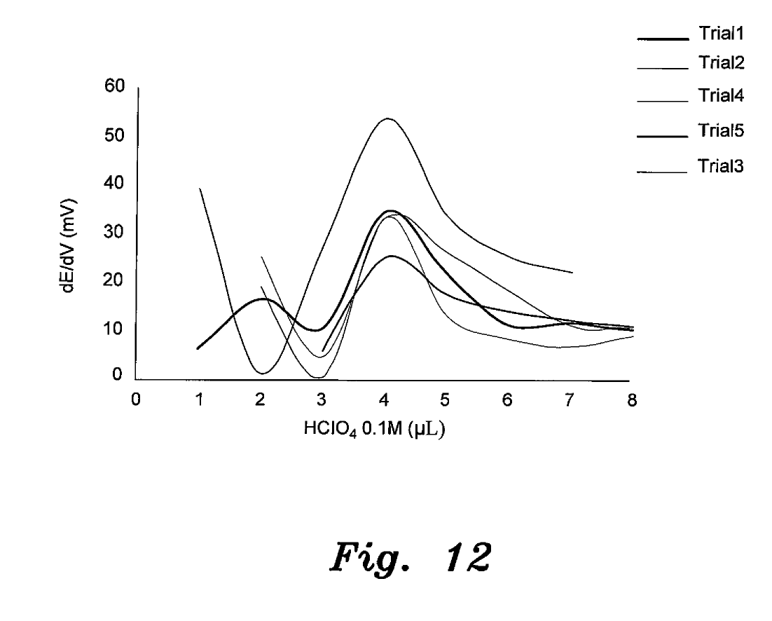

FIG. 11 shows the results for the same test using an antimony electrode, but for a smaller sample size of 10 μL. As shown, the peak becomes smaller and broader with the smaller sample volume. FIG. 12 illustrates the results of the same test, but with the silver electrode coated with carbon nanotubes for a sample volume of 20 μL. As shown, the silver electrode coated with carbon nanotubes produces an endpoint peak with a shape nearly identical to that of the antimony electrode.

FIG. 12 illustrates the results of the same test for the silver electrode coated with carbon nanotubes, but in a small sample size of 5 μL. Table 2 below tabulates the results, with regard to accuracy and precision, of the ketoconazole analysis in both the aqueous and non-aqueous media.

TABLE 2
Accuracy and Precision of Ketoconazole Sample Microtitration

| | | | | Standard |
|---|---|---|---|---|
| Electrode | Sample Mass (mg) | Recovery % | RSD % | Deviation |
| Gold electrode | 0.106 | 101.5 | 1.61 | 0.002 |
| (aqueous) | | | | |
| Silver/CNTs | 0.106 | 99.8 | 4.99 | 0.005 |
| electrode | | | | |
| (aqueous) | | | | |
| Antimony | 0.133 | 99.2 | 1.80 | 0.0025 |
| electrode (non- | | | | |
| aqueous) | | | | |
| Silver/CNTs | 0.106 | 101 | 1.36 | 0.001 |
| electrode (non- | | | | |
| aqueous) | | | | |

It is to be understood that the present invention is not limited to the embodiments described above, but encompasses any and all embodiments within the scope of the following claims.

We claim:

1. A method of making silver electrodes coated with carbon nanotubes, comprising the steps of:
positioning at least one silver electrode within a reaction zone of a floating catalyst chemical vapor deposition reactor;
evaporating a ferrocene catalyst within the floating catalyst chemical vapor deposition reactor;
feeding an inlet gas into the floating catalyst chemical vapor deposition reactor to carry the evaporated ferrocene catalyst into the reaction zone, the inlet gas including a source of carbon;
heating the reaction zone for deposition of carbon from the inlet gas onto the at least one silver electrode to form at least one silver electrode coated with carbon nanotubes;
cooling the at least one silver electrode coated with carbon nanotubes; and
removing the at least one silver electrode coated with carbon nanotubes from the reaction zone of the floating catalyst chemical vapor deposition reactor.

2. The method of making silver electrodes coated with carbon nanotubes as recited in claim 1, wherein the step of evaporating the ferrocene catalyst comprises supporting the ferrocene catalyst in a catalyst boat and placing the catalyst boat and the ferrocene catalyst within a first reaction chamber of the floating catalyst chemical vapor deposition reactor.

3. The method of making silver electrodes coated with carbon nanotubes as recited in claim 2, wherein the step of evaporating the ferrocene catalyst is performed within the first reaction chamber at a temperature of about 120° C.

4. The method of making silver electrodes coated with carbon nanotubes as recited in claim 3, wherein the inlet gas comprises hydrogen gas and acetylene.

5. The method of making silver electrodes coated with carbon nanotubes as recited in claim 4, wherein the step of heating the reaction zone comprises heating the reaction zone to a temperature between 600° C. and 750° C.

6. The method of making silver electrodes coated with carbon nanotubes as recited in claim 5, wherein the heating step is performed for about 15 minutes.

7. The method of making silver electrodes coated with carbon nanotubes as recited in claim 6, wherein the hydrogen inlet gas is introduced into the reaction zone at a flow rate of about 25 ml/min during the heating step.

8. The method of making silver electrodes coated with carbon nanotubes as recited in claim 7, wherein the acetylene inlet gas is introduced into the reaction zone at a flow rate of about 75 ml/min during the heating step.

9. The method of making silver electrodes coated with carbon nanotubes as recited in claim 8, further comprising the step of flushing the floating catalyst chemical vapor deposition reactor with an inert gas prior to reaction.

10. The method of making silver electrodes coated with carbon nanotubes as recited in claim 9, wherein the inert gas is argon.

11. An indicator electrode for microtitrimetry by differential electrolytic potentiometry, comprising a silver electrode coated with carbon nanotubes.

12. The indicator electrode as recited in claim 11, wherein each said carbon nanotube has a diameter between 10 nm and 30 nm.
